(19) United States
(12) Patent Application Publication
(10) Pub. No.: US 2007/0208633 A1
(43) Pub. Date: Sep. 6, 2007

(54) Display article customization system and method of use

(76) Inventor: Ranjie Singh, London (CA)

Correspondence Address: ARENT FOX PLLC, 1050 CONNECTICUT AVENUE, N.W., SUITE 400, WASHINGTON, DC, 20036, US

(21) Appl. No.: 11/713,085

(22) Filed: Mar. 2, 2007

Related U.S. Application Data
(60) Provisional application No. 60/778,910, filed on Mar. 6, 2006.

(51) Int. Cl. G06Q 30/00; G06F 17/00

(52) U.S. Cl. 705/26; 700/233

(57) ABSTRACT

A method and system in which a user can design, customize and order a display article to desired specifications over a network, such as the Internet. The user can access a website comprising the display article customization system to customize the display article by adding text, graphics and other features onto the display article, such as a wristband, and order the customized wristband over the network. The user can access an online data collection and manufacturing control framework capable of accurately generating, processing, and transmitting text and graphics into an automated manufacturing process that fabricates wristbands of varied material construction. All data is transmitted securely between the user and the manufacturing server.

This application claims priority to Applicant's co-pending U.S. Provisional Application Ser. No. 60/778,910 entitled “WRISTBAND CUSTOMIZATION SYSTEM AND METHOD OF USE” filed Mar. 6, 2006. The entirety of this patent application is incorporated herein by reference.

### BACKGROUND OF THE INVENTION

1. Field of the Invention

The present invention relates generally to a method and system for creating a display article to a user's specification, over a network, such as the Internet. In particular, the present invention relates to a method and system in which a user customizes a display article by entering text, graphics and representative communication and other features onto the display article, such as a band or wristband, and orders the customized article over the network. Further, the present invention relates to an online data collection and manufacturing control framework capable of accurately generating, processing, and transmitting text and graphics into a manufacturing process (e.g., an automated process) that fabricates wristbands of varied material construction. The text and graphics are transmitted securely between the user and the manufacturing server, for example.

2. Background of the Technology:

There is an unmet need in the art for a method and system for customizing display articles such as wristbands, and otherwise providing a convenient, controlled and assisted approach to creating an article over a network, such as the Internet.

### SUMMARY OF THE INVENTION

The present invention includes a system in which a user can design, customize and order a display article to desired specifications over a network, such as the Internet. In an embodiment of the present invention, the user accesses a website comprising a display article customization system.

Via the present invention, the user can select from different styles of display articles and colors to apply thereto. The user can also imprint text on the display article, while viewing the text being imprinted, in real time. The user can, by using a computer mouse or other input device or method, perform a virtual move or on-screen positioning of the text by, for example, dragging the text message to position it on the display article. Further, the user can select from a number of clip art graphics or other objects, such as a user-generated collection of artwork or logos, to place on the display article. The user can perform a virtual move or on-screen positioning by dragging each graphical image to position the image on the display article or otherwise positioning each image. The method also allows the user to submit an order for display articles by submitting contact, billing and/or other information into provided dialog boxes.

Example embodiments of the present invention will now be described in accordance with the above advantages. It will be appreciated that these examples are merely illustrative of the invention. Many variations and modifications will be apparent to those skilled in the art.

### BRIEF DESCRIPTION OF THE DRAWINGS

FIG. 1 is a flow chart illustrating the system according to an embodiment of the present invention,

FIG. 2 is an example user input screen that summarizes the process for customizing a display article in accordance with an embodiment of the present invention;

FIG. 3 is the example user input screen of FIG. 2, in which one of the steps for customizing a display article is selected in accordance with an embodiment of the present invention;

FIG. 4 is an example user input screen showing customization of a display article in accordance with an embodiment of the present invention;

FIG. 5 is an example user input screen for customizing a display article style in accordance with an embodiment of the present invention;

FIG. 6 is an example user input screen for selecting the quantity of display articles in accordance with an embodiment of the present invention;

FIG. 7 is an example user input screen for showing the display articles designed and customized by the user;

FIG. 8 is an example user input screen showing how the user can enter a text message on the display article, in accordance with an embodiment of the present invention;

FIG. 9 is an example user input screen in which the user can choose a font for the text message of the display article, in accordance with an embodiment of the present invention;

FIG. 10 is an example user input screen in which the user can choose a font size for the text to display on the article, in accordance with an embodiment of the present invention;

FIG. 11 is an example user input screen showing how the user can choose a graphical image for the display article, in accordance with an embodiment of the present invention;

FIGS. 12A-12D are example user input screens showing information requested for processing the user's order, in accordance with an embodiment of the present invention;

FIG. 13 is an example e-mail screen showing the order information, in accordance with an embodiment of the present invention;

FIG. 14 is an example components diagram for a system, in accordance with an embodiment of the present invention; and

FIG. 15 illustrates a block diagram of various system components, in accordance with an embodiment of the present invention.

### DETAILED DESCRIPTION OF THE INVENTION

In an embodiment of the method and system of the present invention, the user can link to the system by, for example, accessing the Internet through an Internet Service Provider (ISP). In this example, the user can access and launch the system of the present invention by entering the Uniform Resource Locator (URL) of the system in the title bar in the window of the ISP page. The system can also, for example, contain features to limit access to the system, such as features that require the user to register. The system can also include a security feature, wherein the user can enter a user identifier and password to login to the system.

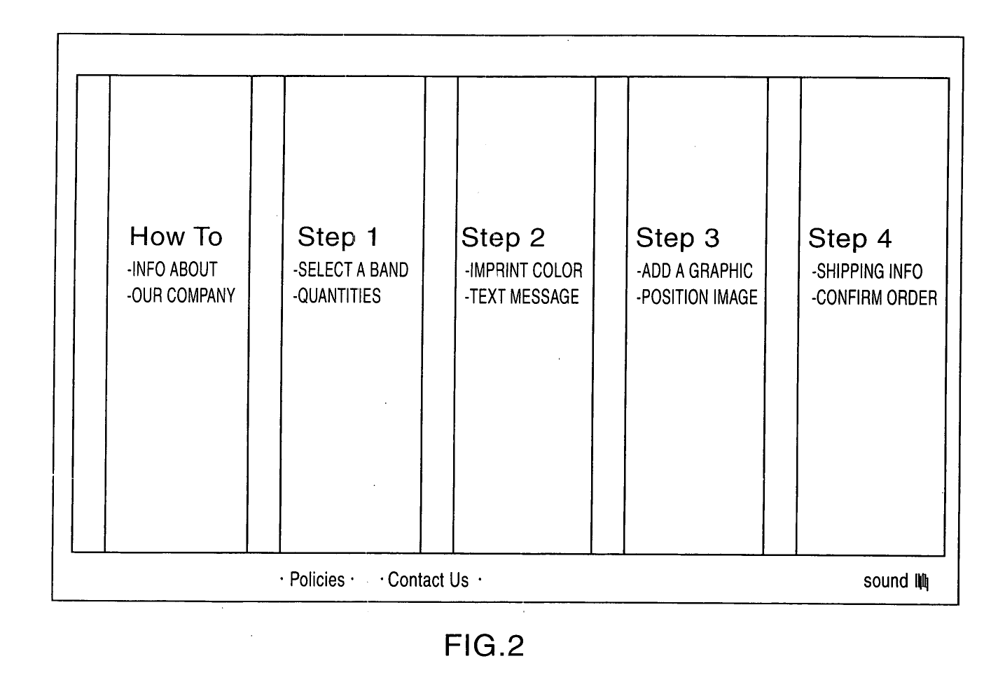

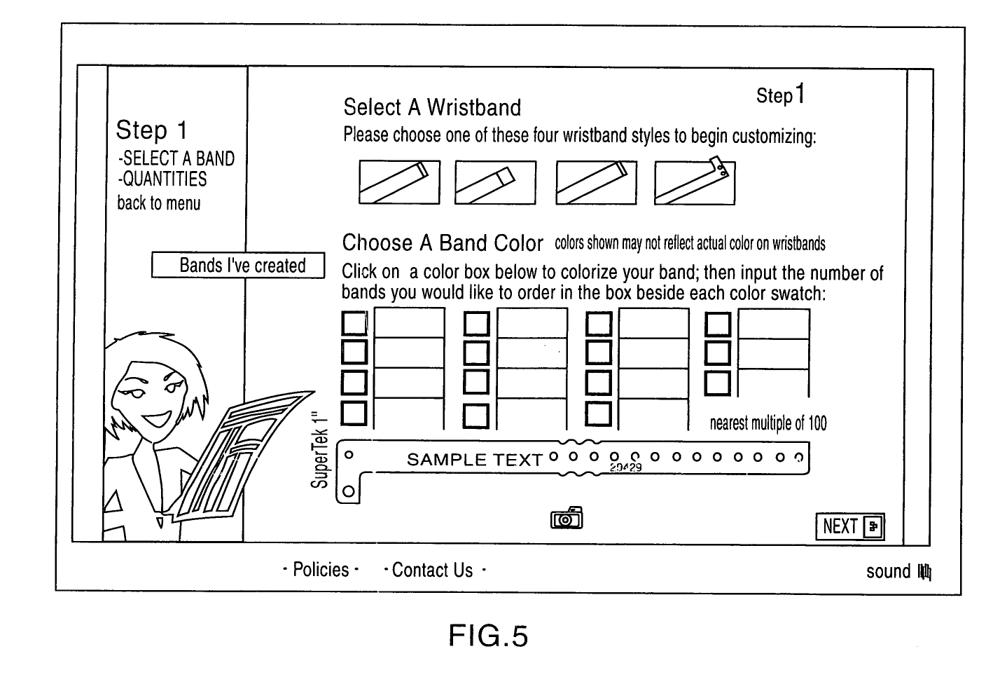

With either the network option described above, or other options for operation, such as via locally accessed software, the user is provided with selections for various options performable through the system. Such input and modifications are made, for example, via a graphical user interface (GUI). The screens of said GUI interface include, for example, prompts for input regarding the user's order. Example GUI screens are presented in FIGS. 2-12D.

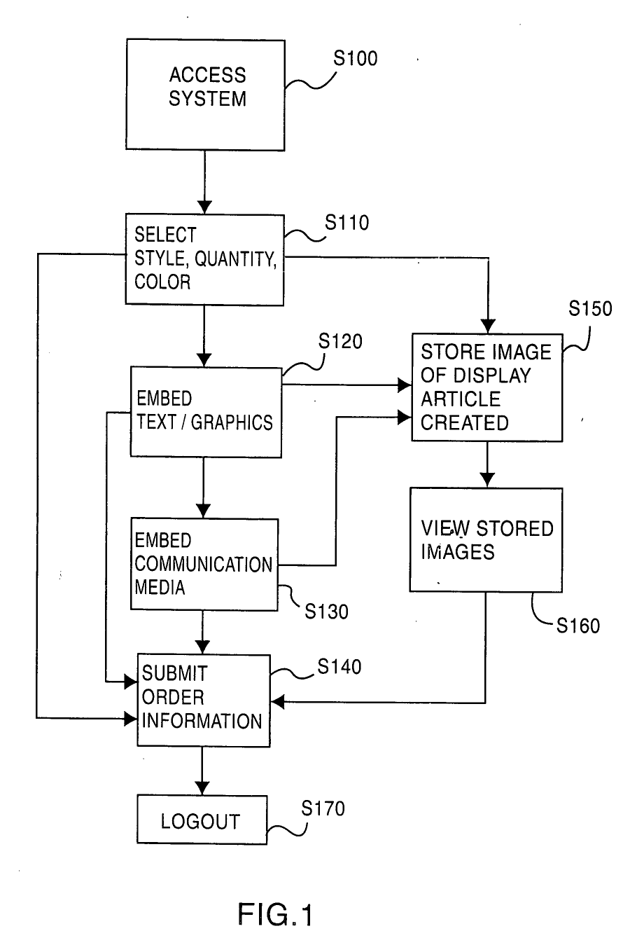

FIG. 1 shows a flowchart of an exemplary operation of the present invention, wherein, the user can perform the outlined steps 100-170 in order to design, customize, store, and order the display articles. At step 100 the user can login to the system for customizing the display article. At step 110, the user can select the style quantity and color of the display article. Further customization of the display article at steps 120-130 allows the user to embed representative communications such as text and graphics and communications into the display article. At any point in the process of customizing the display article, the user can save and store the image of the display article created thus far and submit order information. See e.g., steps 140 and 150. The user can also view the images stored at step 160. After the user has completed the order, the user can log out of the system at step 170.

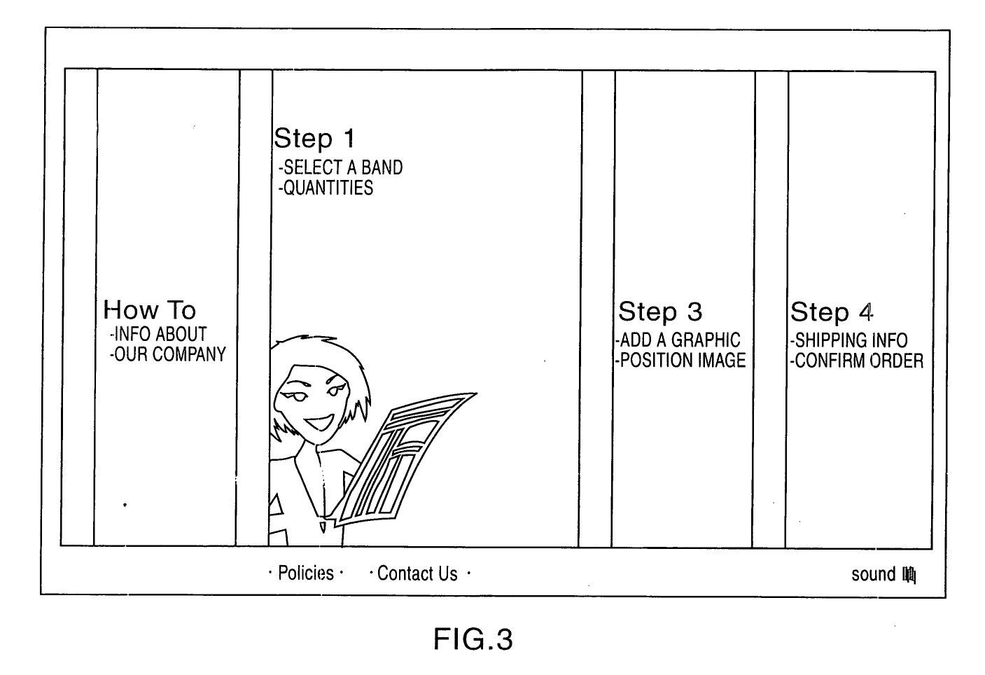

Once the user accesses the system, at step 100 of FIG. 1, for example, the user can choose to enter any of the databases represented by steps 1-3 shown in FIG. 2. As shown in FIG. 3, the selected “step 1” is highlighted to indicate that “step 1” is being accessed by the user.

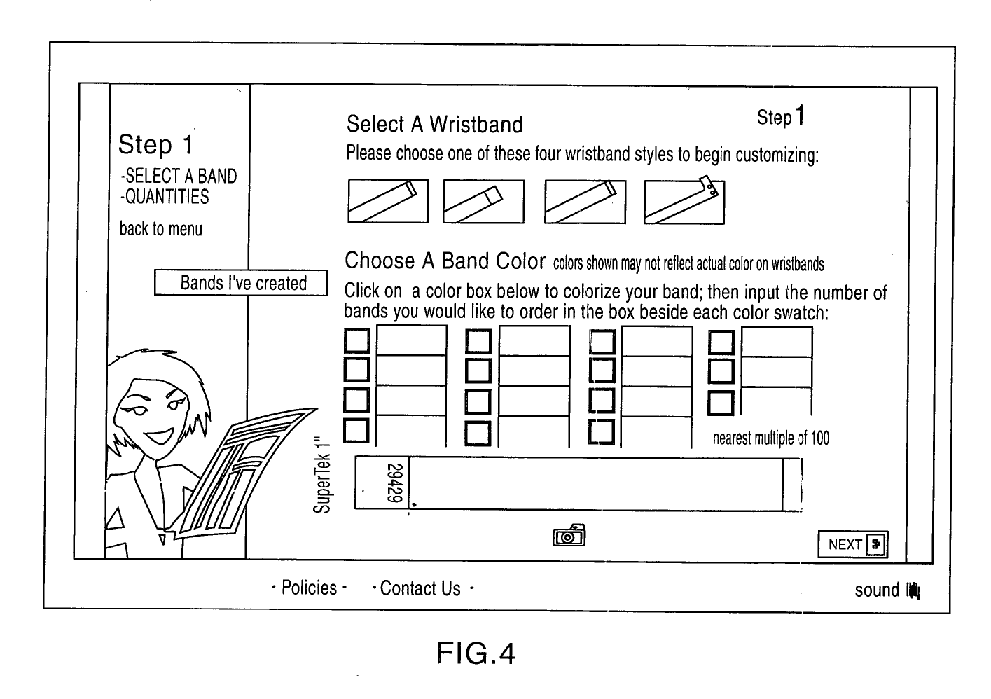

In an embodiment of the present invention, step one can include accessing a database file or other repository containing different display article styles. The user can select the display article style and quantity of display articles to order, as shown in FIGS. 4-6. In the display article style and quantity selection step, the user can be prompted to select a style of the display article, a base color and the quantity of display articles to order. The display article can be, for example, a plain display article or a stylized display article having a particular configuration. As shown in FIGS. 4-6, the user can select from multiple display article styles under the heading “Select a Wristband”. The user selects the wristband by moving a pointer over the icon of the desired wristband and selects or highlights the icon, for example. Selecting the icon can be performed with a computer mouse, for example. Each of the exemplary display articles, as shown, can have not only a different shape or style, but also different lengths and widths. The display articles can include a wristband, tag or label that can be applied to a human body, pets or property. The display article can also include signage, cards, posters, art, nametags, general tags and packaging materials.

After the user selects a display article style, the selected display article can be displayed in the window with a respective style number or identifier.

The user is also prompted to select a display article color, under the heading “Choose a Band Color”. For example, the user can select an article (e.g., band) color by placing the pointer over the color icon showing the desired color, or in the dialog box next to the color icon and selecting the color. Although the figures illustrate sixteen (16) different color choices for the articles, there can be any number of different color choices. Once the user selects a color for the display article, the selected display article style that is currently displayed in the window can be changed to show the color selected. As such, the user can view the display article as it is being created. Although the present application shows a single base color for the entire display article, the system and method of the present invention can also include the option of selecting multiple base colors for the display article or other patterns.

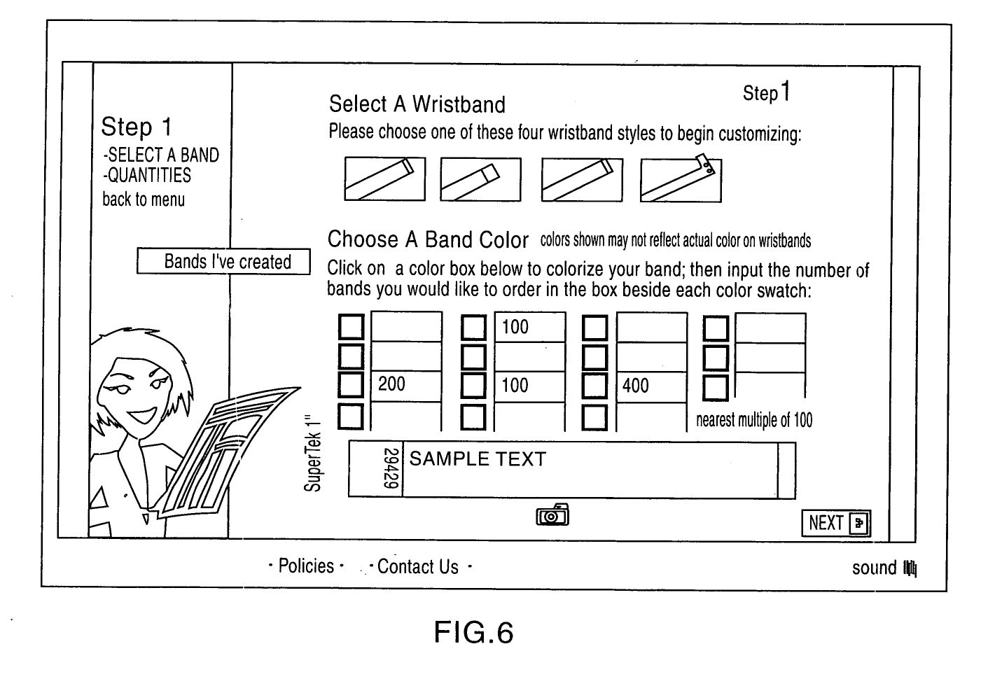

In the display article style and quantity selection step, the user can also input the desired quantity of display articles of a particular color into the dialog box next to the desired color icon. As shown in FIG. 6, for example, the user has selected 200 display articles of the color indicated in column one, row three, 100 display articles of the color indicated in column two, rows one and three, and 400 display articles of the color indicated in column three, row three.

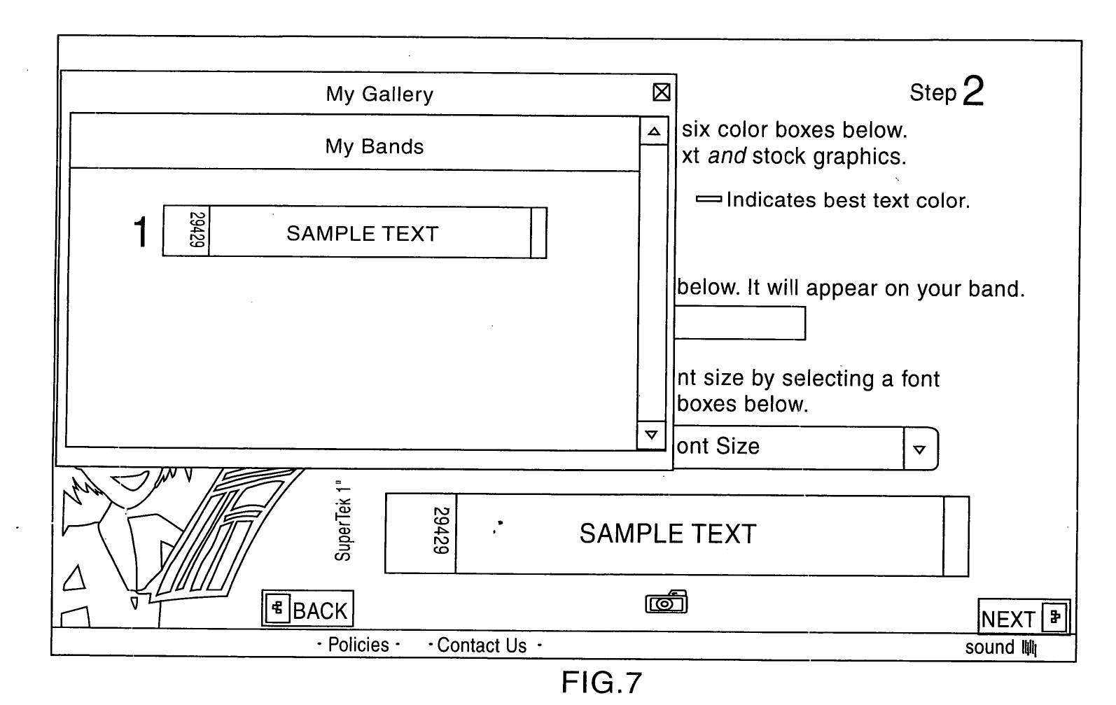

In the exemplary method shown in FIGS. 4-6, when the user has selected to display article styles, colors and quantities, the user can move the pointer over the camera icon, for example, and select the icon to program the system to take a “snapshot” of the display article design, and store the designed and customized display article in a directory of display articles in a manner similar to typical “shopping cart”features on Internet shopping websites. In one embodiment of the present invention, the user can review the directory of stored display articles by selecting the “Bands I've created” icon. When the user selects the “Bands I've created” icon, a pop-up window can open on top of (over) the existing window, showing the display article styles and colors selected. See FIG. 7 showing, as an example, “My Gallery” and “My Bands”.

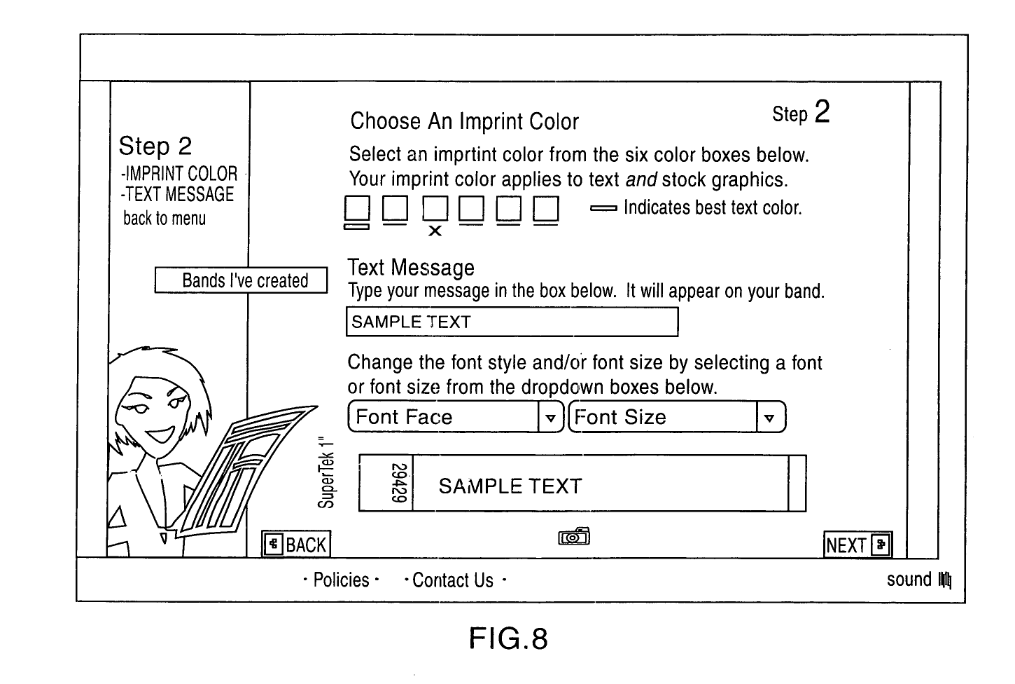

In the text embedding step shown in FIG. 8, the user can choose to embed text having a different color onto the base color of the display article. (See also step 120 of FIG. 1). The selected color can apply to text and graphical images, for example. The user can select the text or graphical image color, for example, by placing the pointer over the icon displaying the desired color and selecting that color. The system may also prompt the user to select a color that would contrast with the base color of the display article and, therefore, have optimum visibility when printed on the base color. For example, as shown in FIG. 8, one of the color icons has an “X” displayed underneath to indicate that that color is not an optimum color for text or graphics, as it might be the same color as the base color. The first icon is provided with an indicator that the first color icon is an optimum color for text or graphics based on the base color of the display article. Each of the remaining color icons (i.e., the second, fourth, fifth and sixth from the left as shown in FIG. 8) is provided with an indicator that the color icons are not the best color choice. However, any of the colors can be selected by the user.

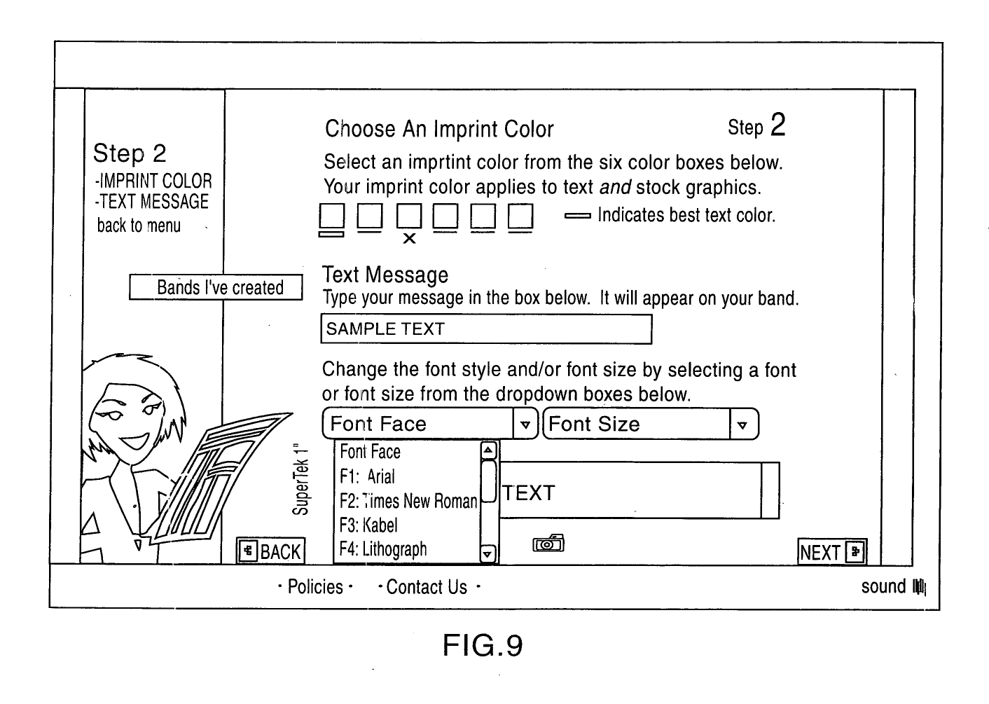

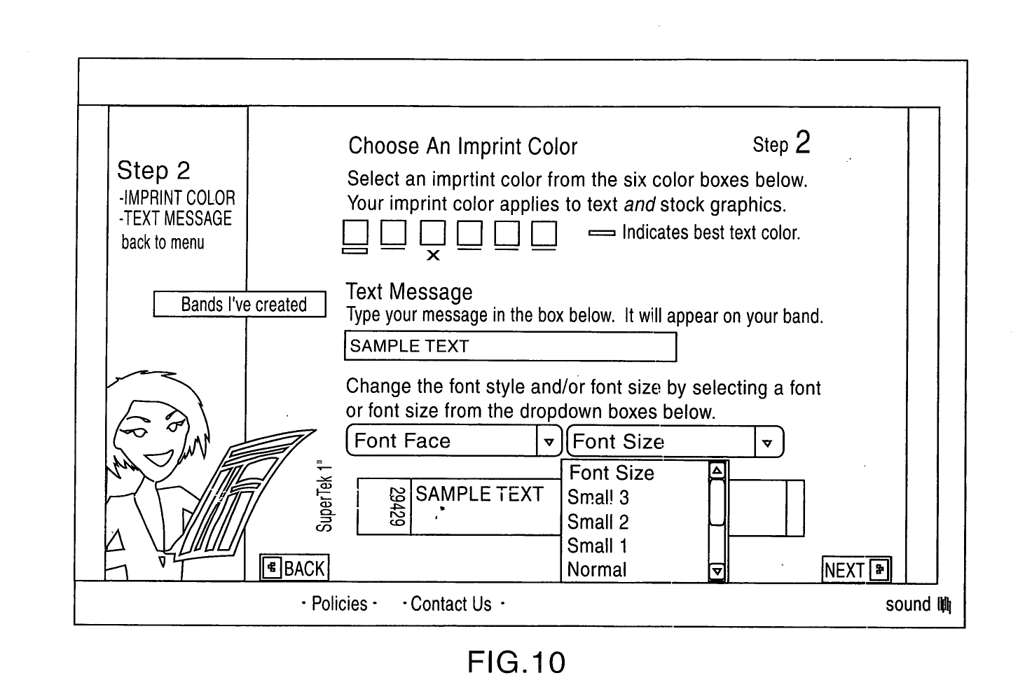

The user can then enter text into a dialog box and the text will appear on the display article image in real time. The user can also select a particular font or a font size for the text message by using the scroll bar to scroll through the menu of fonts and font sizes as shown in FIGS. 9 and 10. The text in the size relative to the display article can be displayed in the window. The user can drag the input text on the display article to the desired position by, for example, moving the pointer over the text and sliding the pointer to a new location.

When the user has embedded the desired text message and selected the font and font size, the user can select the camera icon shown below the image of the display article as customized, or otherwise select to store the images of the display articles in the directory of display articles. The user can store the customized display article in a repository, such as a database. As discussed above, the user can review the selection of customized display articles by selecting the “Bands I've created” icon.

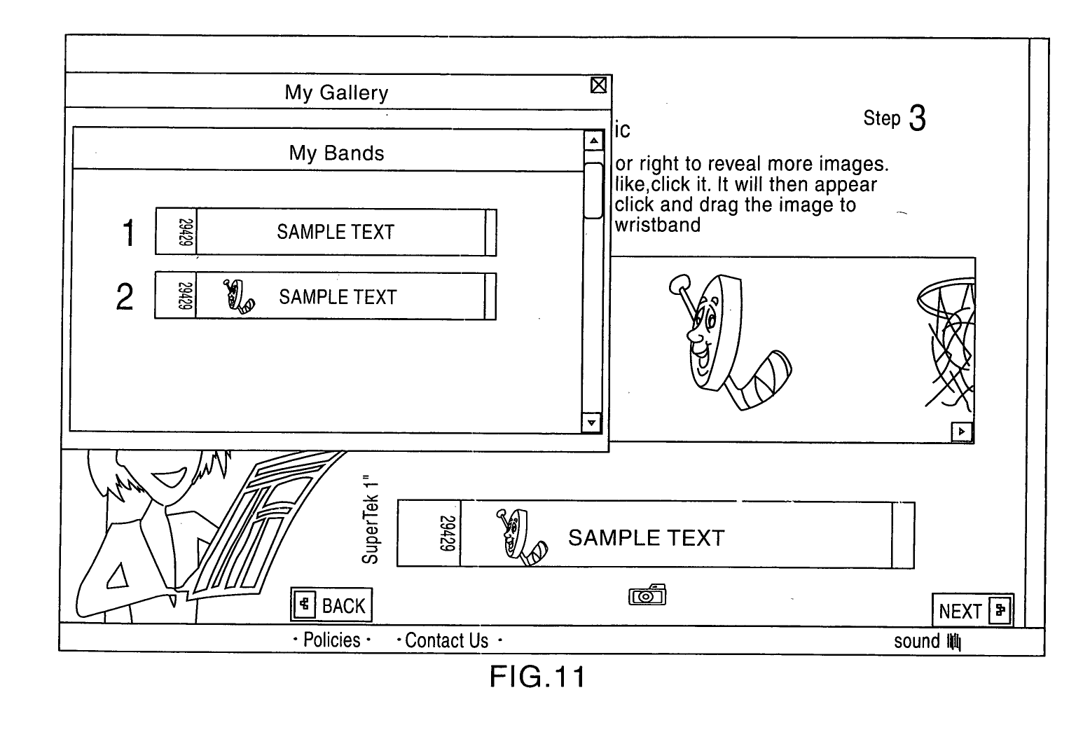

In the graphical image embedding step shown in FIG. 11, the user has the option of adding a graphical image to the display article. The user can then select from any of the existing graphical images or artwork in the system. The user can also upload personalized or user-generated images, artwork or a symbol from a local computer, and position the images on the display article. The system of the present invention can also scale the images to be either smaller or larger. (See also step 120 of FIG. 1).

The exemplary system of the present invention as shown in FIG. 11 is able to embed other representative communications into the display article. Such representative communications can include graphical images for selection by the user in the form of, for example, lenticular images, video images, text messages, light emitting diode (LED) type images or movements, wireless communication or audio, scrolling messages. Communications media can also be embedded into the display article. Such communications media include electronic display screens, such as polymer light-emitting diodes (PLED) or other flexible screens, and organic light-emitting diodes (OLEDs), or any type of media that currently is available on the World Wide Web. (See also step 130 of FIG. 1). Embodiments of the system allow the user to drag the input graphical image across the display article to a desired position by moving the pointer over the graphical image and sliding the pointer to a new location, for example. The display article designed and customized by the user, with the graphic image in position, is then displayed in the GUI.

When the user completes the customization of the display device, the user can move the pointer to the camera icon and select the camera icon to store the image of the display article in the directory of display articles, or otherwise make a storage selection. (See also step 150 of FIG. 1). The user can also view the images stored. (See also step 160 of FIG. 1).

The graphical images can be duplicated so that the display article can have multiple images thereon. The user can also select more than one graphical image to embed into the display article.

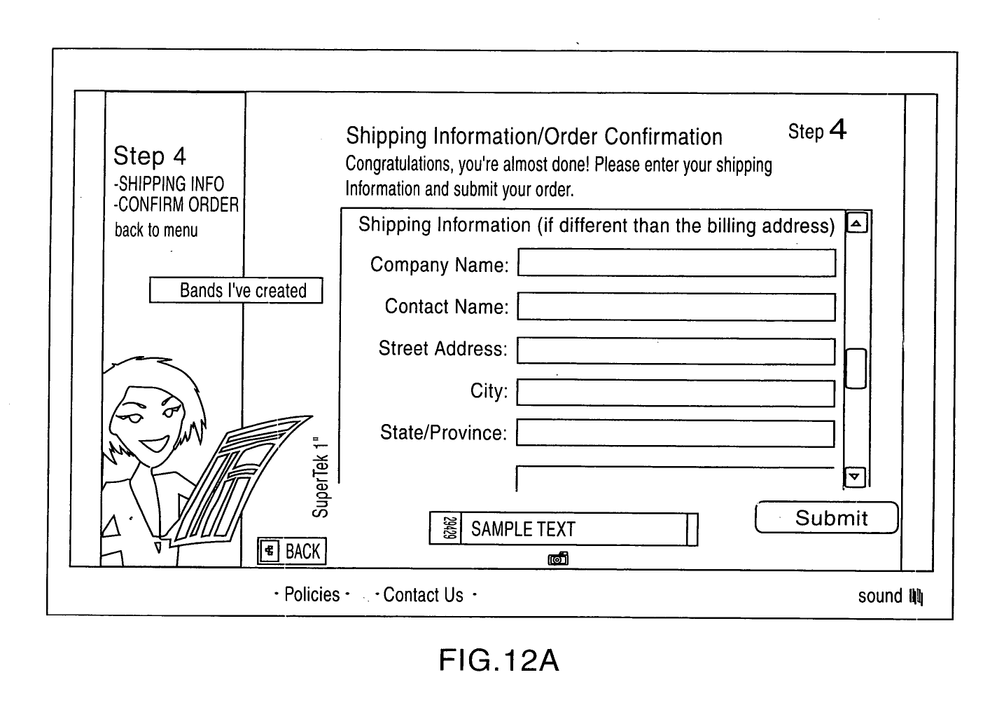

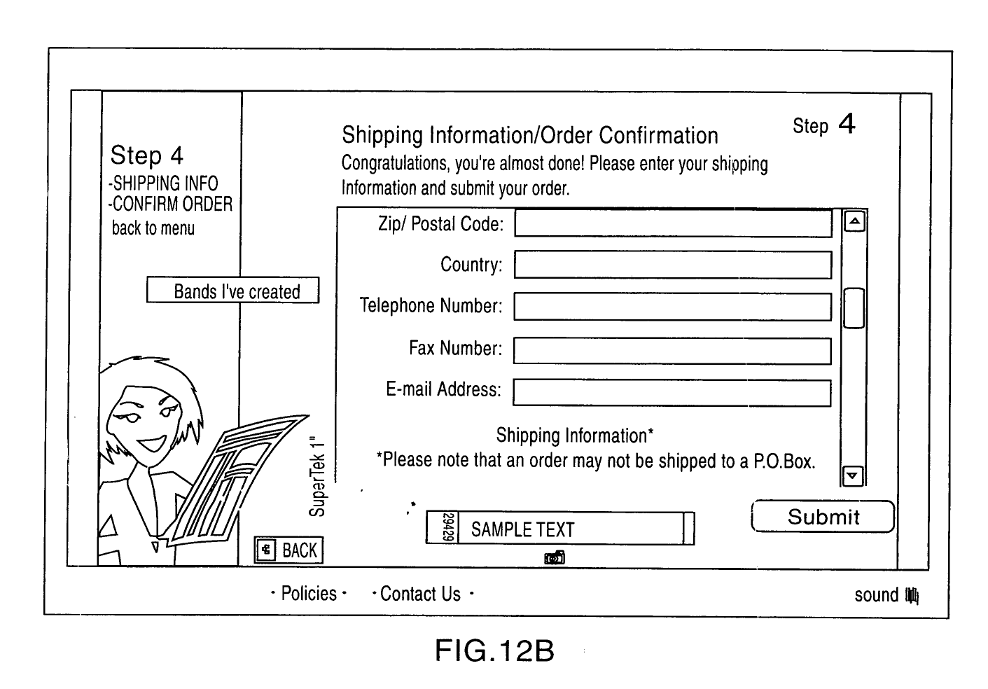

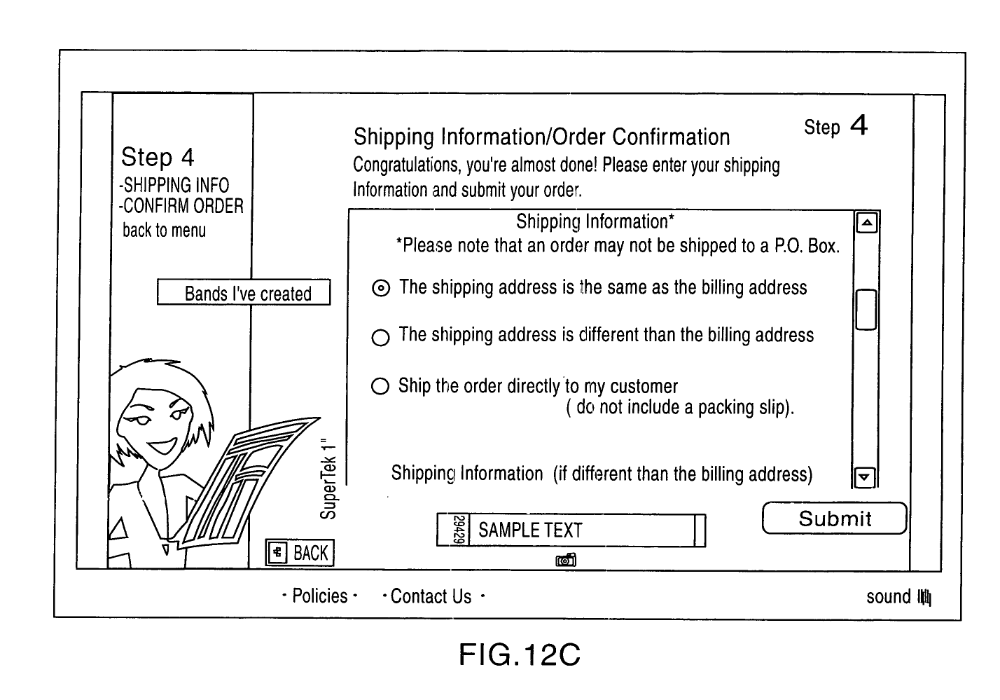

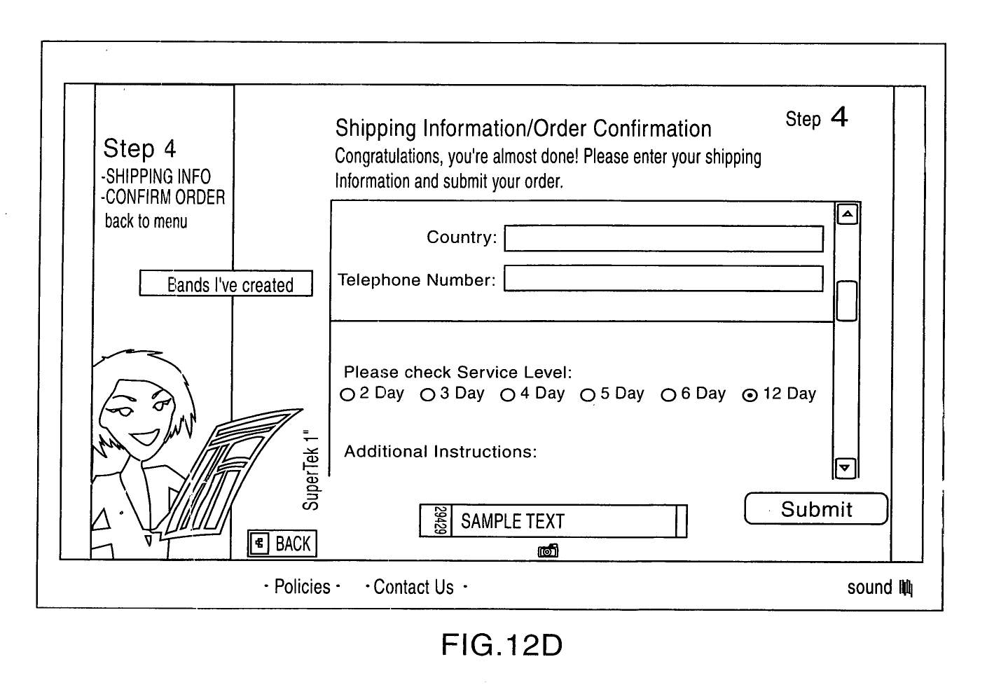

In the shipping information and order confirmation step shown in FIGS. 12A-12D, the user can submit shipping information and receive an order confirmation. The user can enter into the dialog boxes such information as company name, contact name, address, telephone and facsimile numbers, e-mail address, shipping and billing information, level of service, and any instructions regarding the order. (See also step 140 of FIG. 1).

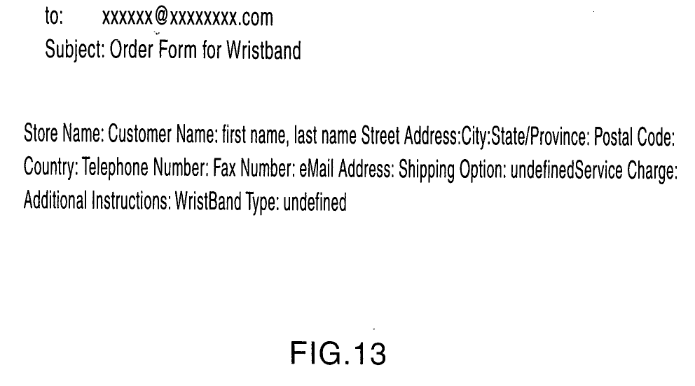

The user can review the stored display articles and order some or all. In an embodiment of the present invention, the user can order the display articles by selecting the “submit” icon that delivers an e-mail message to the system provider or other fulfillment entity with the order information, including an attachment of the designed and customized display articles (see FIG. 13). In another embodiment of the present invention, when the user selects the “submit” icon, the order information can be uploaded to a server at a production facility for manufacture.

Although FIGS. 2 and 3 show that the method and system of the present invention has four steps, the system does not require, nor is it limited to four steps. Also, at any stage of the user's input, the user can return to the previous screen, select and deselect a display article and repeat any of the above steps, or exit the system. After the user has completed the order, the user can log out of the system.

The method and system of the present invention can allow the user to imprint on or embed in the display article, not only fixed graphics, but also moving graphics, such as an alterable or lenticular image, wherein viewing the image from different angles creates the appearance that the image or text are moving. In another variation, the method and system of the present invention can embed an alterable image that displays a continuum of images for a predetermined time, such as a movie clip. In another variation, the method and system of the present invention can embed an illuminated alterable image, such as flashing LEDs. In another variation, the method and system of the present invention can embed an electronic imaging receiving and/or transmitting section that can receive wireless transmitted images or other information. For example, images or messages, such as advertisements or announcements can be transmitted from a remote location (e.g., from a device having a processor and transmitter receiver) to the display article for receipt by the display article. Multiple messages can be embedded in the image. Other features of the display article such as but not limited to those disclosed in applicant's U.S. Provisional Patent Application Ser. No. 60/740,682, filed Nov. 30, 2005, entitled “Customizable Display Having an Alterable Image”, U.S. Provisional Application Ser. No. 60/809,797 entitled “Multi-Media display Device” filed Jun. 1, 2006 and U.S. patent application Ser. No. 11/605,477 entitled “Customizable Display Device” filed Nov. 29, 2006, are hereby incorporated by reference.

The display article can be a collectible item used to commemorate events, such as sporting events, movie previews, concerts, and community events. The display article can also be used in advertising by food and beverage companies, restaurants, and other businesses to promote goods and services, activities, new launches or new amusements.

The display articles customized in accordance with the present invention can be used to provide a fixed message, such as for identification, security control, drinking age verification, advertising, and as a novelty item.

The method and system of the present invention can also include the feature of adding an audio portion, such as to provide entertainment to the user while the user is operating the system, using similar features to those for adding graphics to articles.

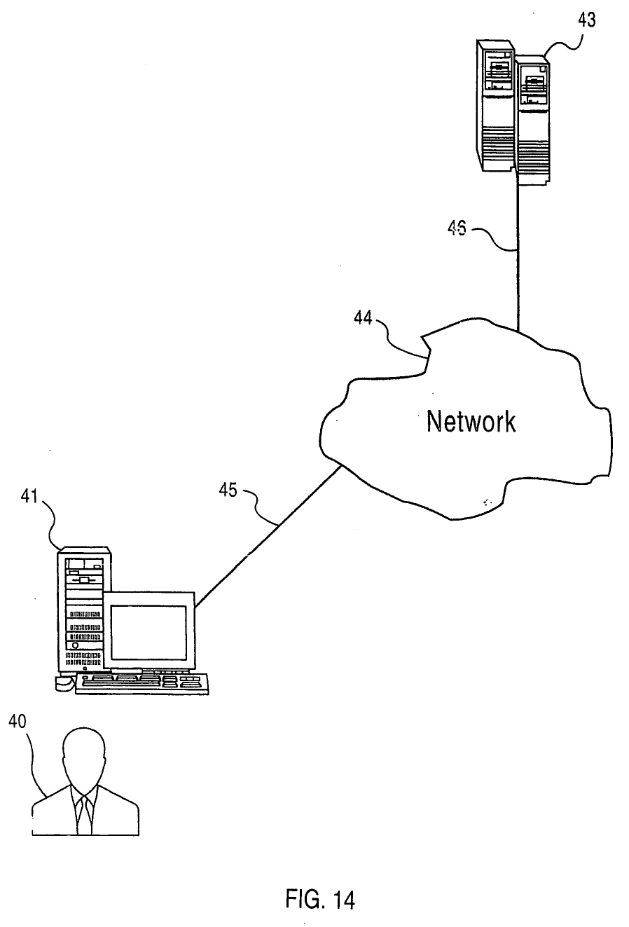

Access to the database and capabilities of the system of an embodiment of the present invention occur via hardware and access selections. As shown in FIG. 14, in an embodiment of the present invention, with one option, a user 40, can use locally loaded software at the user's terminal 41, such as a personal computer (PC), minicomputer, microcomputer, mainframe computer, telephone device, hand-held device such as a personal digital assistant (PDA), or other wireless device with a processor, display, and capability of connecting to a network 44, such as the Internet. The user 40 can use the terminal to access a server 43 via couplings 45, 46. The server 43 includes, for example, a PC, minicomputer, microcomputer, mainframe computer, or other device having a processor and a repository for data or connection to a repository for data. The couplings 45, 46 include, for example, wired, wireless, or fiberoptic connections. In another embodiment, the method and system of the present invention operate in a stand-alone environment, such as on a single terminal.

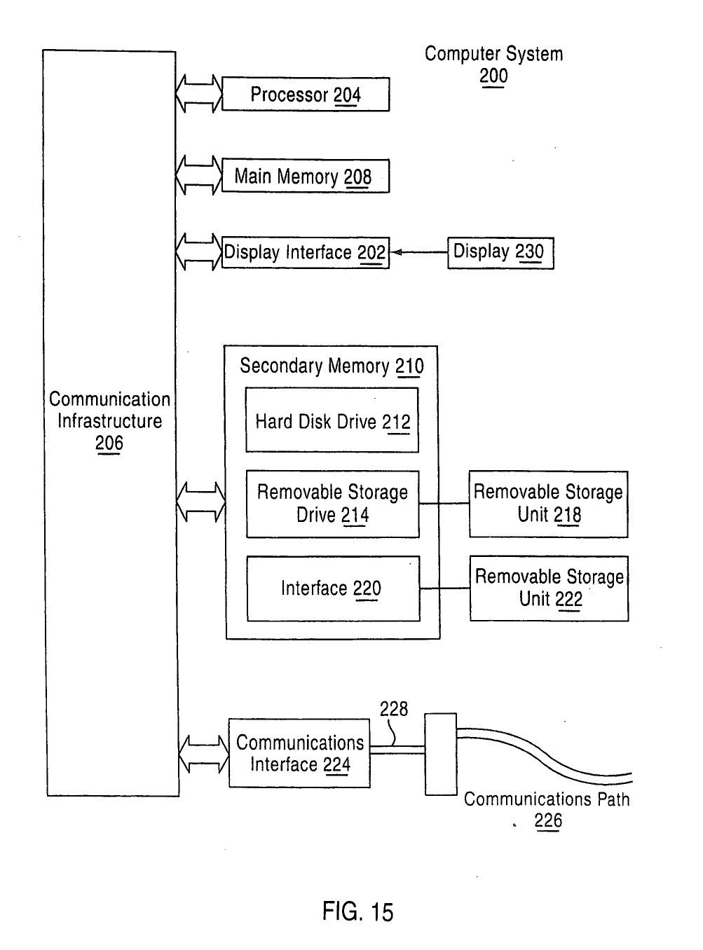

The present invention may be implemented using hardware, software or a combination thereof and may be implemented in one or more computer systems or other processing systems. In an embodiment, the invention is directed toward one or more computer systems capable of carrying out the functionality described herein. An example of such a computer system 200 is shown in FIG. 15.

Computer system 200 includes one or more processors, such as processor 204. The processor 204 is connected to a communication infrastructure 206 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on the display unit 230. Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well-known manner. Removable storage unit 218, represents a floppy disk, magnetic tape, optical disk, etc., which is read by and written to removable storage drive 214. As will be appreciated, the removable storage unit 218 includes a computer usable storage medium having stored therein computer software and/or data.

In alternative embodiments, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred through communications interface 224 are in the form of signals 228, which may be electronic, electromagnetic, optical or other signals capable of being received by communications interface 224. These signals 228 are provided to communications interface 224 through a communications path (e.g., channel) 226. This path 226 carries signals 228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 214, a hard disk installed in hard disk drive 212, and signals 228. These computer program products provide software to the computer system 200. The invention is directed to such computer program products.

Computer programs (also referred to as computer control logic) are stored in main memory 208 and/or secondary memory 210. Computer programs may also be received through communications interface 224. Such computer programs, when executed, enable the computer system 200 to perform the features of the present invention, as discussed herein. In particular, the computer programs, when executed, enable the processor 204 to perform the features of the present invention. Accordingly, such computer programs represent controllers of the computer system 200.

In an embodiment where the invention is implemented using software, the software may be stored in a computer program product and loaded into computer system 200 using removable storage drive 214, hard drive 212, or communications interface 224. The control logic (software), when executed by the processor 204, causes the processor 204 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

Although the invention has been described based upon these preferred embodiments, it would be apparent to those skilled in the art that certain modifications, variations, and alternative constructions would be apparent, while remaining within the spirit and scope of the invention. In order to determine the metes and bounds of the invention, therefore, reference should be made to the appended claims.

What is claimed is:

1. A method of customizing a display article, the method comprising:
providing access to a first data set containing characteristics of the display article;
receiving a selection of characteristics of the display article with respect to the first data set;
providing access to a second data set containing representative communications of the display article;
receiving a selection of representative communications to be embedded into the display article with respect to the second data set; and
providing an order for the display article based on the received selection of characteristics and representative communications.

2. The method according to claim 1, further comprising:
storing the display article image having the received selection of characteristics and representative communications.

3. The method according to claim 2, further comprising:
providing an option to review the stored data for the display article.

4. The method according to claim 1, further comprising:
transmitting the order to a manufacturer for production.

5. The method according to claim 1, wherein receiving a selection of characteristics of the display article comprises:
selecting a style and color of the display article.

6. The method according to claim 1, wherein receiving a selection of representative communications to be embedded into the display article comprises:
embedding user-generated graphical images and text.

7. The method according to claim 6, wherein embedding images and text comprises:
embedding graphical images and text in a selected font size and font face.

8. The method according to claim 6, wherein embedding representative communications comprises:
embedding graphical images and text in a color that contrasts with a color of the display article.

9. The method according to claim 1, wherein receiving a selection of representative communications to be embedded into the display article comprises:
embedding a communication on an electronic display screen selected from the group consisting of electronic display screens, polymer light-emitting diodes (PLED) and organic light-emitting diodes (OLEDs).

10. The method according to claim 1, wherein receiving a selection of characteristics of the display article comprises:
selecting a plurality of colors in different quantities for the display article.

11. The method according to claim 1, wherein the display article is a wristband.

12. The method according to claim 1, wherein the representative communications comprise lenticular images.

13. The method according to claim 1, wherein the representative communications comprise video images.

14. The method according to claim 1, wherein the representative communications comprise audio communications.

15. The method according to claim 1, wherein the representative communications comprise a communication received by an electronic receiving section.

16. The method according to claim 1, wherein the representative communications comprise a communication transmitted by an electronic transmitting section.

17. A system for enabling a user to customize a display article, the system comprising:
means for providing access to a first data set;
means for receiving a selection of characteristics of the display article with respect to the first data set;
means for providing access to a second data set;
means for receiving a selection of representative communications to be embedded into the display article with respect to the second data set;
providing an order for the display article based on the received selection of characteristics and representative communications.

18. The system according to claim 17, wherein the means for receiving a selection of characteristics comprises:
visual prompts for directing the user to select a display article style.

19. The system according to claim 17, wherein the means for receiving a selection of characteristics of the display article comprises:
selecting the characteristics of a wristband.

20. The system according to claim 17, wherein the means for receiving a selection of representative communications to be embedded into the display article comprises:
selecting a color for the representative communications that contrasts with a color of the display article.

21. The system according to claim 17, further comprising means for displaying a plurality of customized display article images in a pop-up window within a graphical user interface.

22. A system for enabling a user to customize a display article, the system comprising:
a processor;
a user interface functioning via the processor; and
a repository accessible by the processor;
wherein a first set of input data specifying characteristics of the display article is received and stored in the repository;
wherein a second set of input data specifying representative communications of the display article is received and stored in the repository; and
wherein a first set of output data is identified via the processor; and
wherein the first set of output data is presented via a graphical user interface.

23. The system according to claim 22, wherein the processor is housed on a terminal.

24. The system according to claim 23, wherein the terminal is selected from a group consisting of a personal computer, a minicomputer, a main frame computer, a microcomputer, a hand held device, and a telephonic device.

25. The system according to claim 22, wherein the processor is housed on a server.

26. The system according to claim 25, wherein the server is selected from a group consisting of a personal computer, a minicomputer, a microcomputer, and a main frame computer.

27. The system according to claim 25, wherein the server is coupled to a network.

28. The system according to claim 27, wherein the network is the Internet.

29. The system according to claim 27, wherein the server is coupled to the network via a coupling.

30. The system according to claim 29, wherein the coupling is selected from a group consisting of a wired connection, a wireless connection, and a fiberoptic connection.

31. The system according to claim 22, wherein the repository is housed on a server.

32. The system according to claim 31, wherein the server is coupled to a network.

33. A computer program product comprising a computer usable medium having control logic stored therein for causing a computer to customize a display article, the computer program product comprising:
first computer readable program code means for providing access to a first data set containing characteristics of the display article and receiving a selection of characteristics of the display article with respect to the first data set;
second computer readable program code means for providing access to a second data set containing representative communications of the display article and receiving a selection of representative communications to be embedded into the display article with respect to the second data set; and
third computer readable program code means for providing an order for the display article based on the received selection of characteristics and representative communications.
